(19) United States
(12) Patent Application Publication
(10) Pub. No.: US 2007/0288240 A1
(43) Pub. Date: Dec. 13, 2007

(54) USER INTERFACE FOR TEXT-TO-PHONE CONVERSION AND METHOD FOR CORRECTING THE SAME

(75) Inventors: Liang-Sheng Huang, Taipei City (TW); Tien-Ming Hsu, Taipei City (TW); Chien-Chou Hung, Taipei County (TW); Keng-Hung Yeh, Taoyuan County (TW); Min-Hong Wang, Hsinchu City (TW); Jia-Lin Shen, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/689,155

(22) Filed: Mar. 21, 2007

(30) Foreign Application Priority Data
Apr. 13, 2006 (TW) 095113247

(51) Int. Cl. G10L 13/00

(52) U.S. Cl. 704/260

(57) ABSTRACT

A user interface for a text-to-phone conversion and the method for correcting the results of the text-to-phone in the user interface are provided. The user interface for the text-to-phone conversion comprises a vocabulary column, a pronunciation column, a category column, and an index column. The vocabulary column is displaying a word having at least one letter. The pronunciation column is displaying a pronunciation corresponding to the word. The category column is displaying a specific source corresponding to the corresponding pronunciation. The index column is displaying a specific confidence score corresponding to the pronunciation. The present invention could highly increase the processing rate and the usage convenience of the correctable interface during the text-to-phone conversion.

### FIELD OF THE INVENTION

The present invention relates to a user interface for a text-to-phone conversion and the method for correcting the same. More particularly, the present invention relates to a user interface for a text-to-phone conversion and the method for correcting the same in the field of the speech recognition.

### BACKGROUND OF THE INVENTION

In the speaker-independent speech recognition field, such as Hmm-based speech recognition, vocabulary words are firstly converted from the text into the corresponding phonetic symbols. In addition, each of the phonetic symbols corresponds to a phonetic acoustic model. For each word, a word acoustic model is formed by the concatenation of the corresponding phonetic acoustic models of that word. The word model is then provided to the recognition engine for further calculation.

Since one word probably has multiple pronunciations, the incorrect pronunciation might exist in the dictionary, or new words are always created as time goes by, pronunciation rules are necessary to assist the generation of the correct phonetic symbols during the text-to-phone conversion process. However, while the pronunciation rules fail to be applicable in those new words, it easily results in some errors during the text-to-phone conversion process. For example, the Chinese word [symbol] should be pronounced as “d a n sh ax n”, but sometimes it could be, however, converted as “sh a n sh ax n”. Besides, the English word “record” as a noun should be pronounced as “r eh k r d”, whereas the English word “record” as a verb should be pronounced as “r ih ‘k or d”, so that the respective phonetic symbols “r eh k r d” and “r ih ‘k or d” might be misunderstood. Moreover, although the trademark “BenQ” fails to be found in the dictionary, it should be pronounced as “b eh n k” based on the pronunciation rules, but such trademark is, however, read as “b eh n k y uw” by everyone.

The text-to-phone mistakes described above could raise the error rate of speech recognition. And the limited pronouncing dictionaries and the pronouncing rules are hard to satisfy the generation of those new words continuously created from the daily life. Therefore, a graphical user interface is often provided in a speech recognition system so that the user is able to correct these phonetic symbols or vocabularies.

Nevertheless, all of the vocabulary words and phonetic symbols are listed simultaneously in the traditional graphical user interface (GUTI) without providing any further reference for judging the accuracy of the phonetic symbols, so that the user must check every word one by one to examine the pronunciation. While the amount of the vocabulary gets large, this kind of manual correction appears to be time-consuming, unfriendly and unpractical.

In order to overcome the drawbacks in the prior art, a user interface for a text-to-phone conversion and the method for correcting the pronunciation of the text-to-phone conversion in the user interface are provided. The particular design in the present invention not only solves the problems described above, but also is easy to be implemented. Thus, the invention has the utility for the industry.

### SUMMARY OF THE INVENTION

The present invention provides a user interface for a text-to-phone conversion and the method for correcting the pronunciations in the user interface, where an offline interface and the method thereof are provided to facilitate the subsequent speech recognition.

In accordance with one aspect of the present invention, a user interface for a text-to-phone conversion is provided. The user interface for a text-to-phone conversion comprises a vocabulary column, a pronunciation column, a category column, and an index column. The vocabulary column is used for displaying a word having at least one letter. The pronunciation column is used for displaying a pronunciation corresponding to the word. The category column is used for displaying a specific source corresponding to the pronunciation. The index column is used for displaying a specific confidence score corresponding to the pronunciation. Accordingly, the confidence score could be a good clue for users to modify the pronunciation corresponding to each of the words in the vocabulary.

Preferably, the vocabulary is presented in one of Chinese and English.

Preferably, the specific source is one selected from a group consisting of a frequently-used-word (FUW) database, a pronouncing dictionary, a speech correction, and a pronouncing rule.

Preferably, the user interface further comprises a labeling column identifying whether the pronunciation is selected.

Preferably, the word, the pronunciation, and the specific source corresponding to the specific confidence score are displayed in the same color of the specific confidence score.

Preferably, the user interface further comprises a setting interface setting a color for the specific confidence score.

Preferably, the user interface further comprises a sub-pronunciation selection menu displaying a specific sub-pronunciation corresponding to a part of the word, wherein the specific sub-pronunciation includes a plurality of pronouncing phonetic symbols, and a part of the pronunciation is determined by the specific sub-pronunciation.

Preferably, the user interface further comprises an input interface to select a respective sub-pronunciation for the part of the word.

Preferably, the input interface is one selected from a group consisting of a keyboard, a mouse, a touch panel, a stylus, and a speech input device.

In accordance with another aspect of the present invention, a method for correcting the pronunciation of a text-to-phone conversion in a user interface is provided. The user interface for a text-to-phone conversion has been described as the above, and the method for correcting the pronunciation comprises the following steps: (1) selecting a part of the word; (2) displaying a plurality of sub-pronunciations corresponding to the selected part of the word, wherein the selected sub-pronunciation determines a part of the pronunciation of the word; and (3) selecting a desired one from the plurality of sub-pronunciations for correcting the part of the pronunciation. Accordingly, accurate acoustic models corresponding to the modified pronunciations can be provided to facilitate the subsequent speech recognition.

Preferably, the vocabulary is in one of Chinese and English.

Preferably, a user interface is provided for selecting the part of the word and the respective sub-pronunciation.

Preferably, the method for correcting the pronunciation of the text-to-phone conversion in the user interface further comprises a step of selecting at least one of other pronunciations for the word according to the specific confidence score.

In accordance with a further aspect of the present invention, a method for correcting the pronunciation of a text-to-phone conversion in a user interface is provided. The user interface for a text-to-phone conversion has been described as the above, and the method for correcting the pronunciation comprises the following steps: (1) selecting a word to provide a lexicon, which includes a first plurality of pronunciations corresponding to the selected word; (2) inputting a respective speech of the selected word to the user interface; (3) starting a speech recognition to obtain a second plurality of pronunciations to the selected word; and (4) selecting a desired one from the second plurality of pronunciations and displaying the selected one.

Preferably, the lexicon is provided from a specific pronouncing combination of the word.

Preferably, the vocabulary is in one of Chinese and English.

Preferably, the user interface furter comprises a category column displaying a source corresponding to the pronunciation.

Preferably, the source is selected from a group consisting of a frequently-used-word (FUW) database, a pronouncing dictionary, a speech correction, and a pronouncing rule.

Preferably, the word, the pronunciation, and the source corresponding to the specific confidence score are displayed in the same color of the specific confidence score.

Preferably, the user interface further comprises a color-setting sub-interface, and the method further comprises a step of changing a color displayed in the color-setting sub-interface.

Preferably, the user interface further comprises a labeling column, and the method further comprises a step of determining whether the pronunciation is selected.

Preferably, the method for correcting the pronunciation of the text-to-phone conversion in the user interface further comprises a step of selecting at least one of other pronunciations for the word according to the specific confidence score.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram of a user interface for a text-to-phone conversion according to a preferred embodiment of the present invention;

FIG. 2 is a schematic diagram of a color-setting interface of the user interface for a text-to-phone conversion in FIG. 1 according to the present invention;

FIG. 3 is a schematic diagram showing a part of the user interface for the text-to-phone conversion in FIG. 1 according to the present invention; and

FIG. 4 is a flowchart of a method for correcting the user interface for a text-to-phone conversion and the method thereof according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

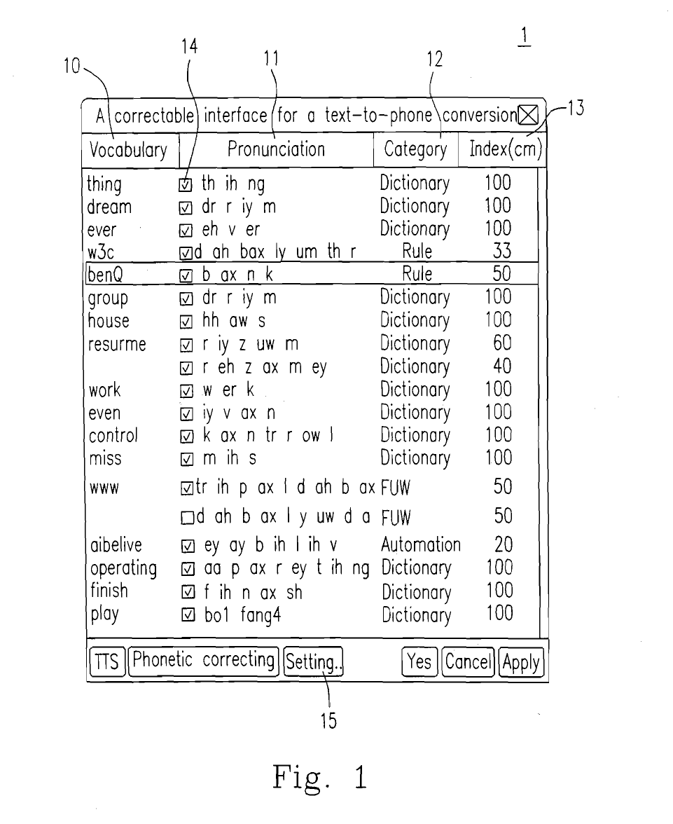

Please refer to FIG. 1, which depicts a scheme diagram of a user interface for a text-to-phone conversion according to a preferred embodiment of the present invention. An interface 1 of the user interface for the text-to-phone conversion at least comprises a vocabulary column 10, a pronunciation column 11, a category column 12 and an index column 13.

As illustrated in FIG. 1, the vocabulary column 10 is used for displaying a plurality of words, each of which has at least one letter. The pronunciation column 11 is used for displaying at least one pronunciation corresponding to the plurality of words, where each pronunciation comprises a plurality of phonetic symbols. The category column 12 is used for displaying a specific source corresponding to each of the at least one pronunciation, and the index column 13 is used for displaying a specific confidence score corresponding to each of the at least one pronunciation. Accordingly, users could modify the pronunciation corresponding to the word with the reference of the specific confidence score.

It should be noted that the plurality of words described in the present invention could be presented in Chinese, English, or other kinds of languages. The method for correcting the pronunciations of the present invention is applicable to any kind of vocabulary, as long as the words could be pronounced by letters. Nevertheless, for convenient description, English words such as “resume” and “benQ” are used hereinafter as examples. However, the present invention can also be applicable to the Chinese word, such as “ [symbol] ”, and other kinds of languages.

In the following, real words listed in FIG. 1 are taken as examples for illustration. As illustrated in FIG. 1, the word “resume” listed in row 8 is a word consisted of English letters, and the pronunciation column 11 corresponding thereto has two respective pronunciations “r iy z uw m” and “r eh z ax m ey” provided for a farther selection. The category column 12 displays the source of the two respective pronunciations “r iy z uw m” and “r eh z ax m ey”, which come from “dictionaries”. The index column 13 displays the two respective confidence scores “60” and “40” corresponding to the two respective pronunciations, which represent the usage frequency of the respective pronunciations “r iy z uw m” and “r eh z ax m ey”.

In FIG. 1, each pronunciation corresponding to every word in the vocabulary could be obtained from a frequently-used-word (FUW) database, a pronouncing dictionary, and so on.

The first distinguiushable technical feature of the present invention is to provide an index column for the traditional user interface during a text-to-phone conversion process, so that the burden to check every text-to-phone conversion error one by one could be highly reduced. Furthermore, taking the English word “computer” for example, there is only one pronunciation for the word described in a pronouncing dictionary, and thus its confidence score is set to be 100. Moreover, taking the abbreviation word “www” listed in row 14 of FIG. 1 for example, where the word is obtained from the FUW database previously set up, it is found that there are two kinds of pronunciations (referring to the pronunciations) “tr ih p ax l d ah b ax l y uw” and “d ah b ax l y uw d ah b ax l y uw d ah b ax l y uw”. However, according to the common usage of the users, approximate 60% people adopt the former pronunciation and approximate 40% people adopt the latter one, and thus the respective confidence scores thereof are set to be “60” and “40” respectively. Accordingly, the users could focus on only those words with low confidence scores and correct the corresponding pronunciations. Therefore, with the assistance of the index column 13, the operating time in the traditional GLTI without providing the confidence score as a reference could be saved, and users will not have to check the words one by one to testify their pronunciations. Simultaneously, under the circumstance of huge-size vocabulary, the operating speed in the user interface for a text-to-phone conversion could be extremely improved by taking the confidence-scores as a reference.

The interface 1 illustrated in FIG. 1 further comprises a labeling column 14. The labeling column 14 is used to label a selected pronunciation from the possible pronunciations corresponding to the word according to the specific confidence-score. For example, the confidence score, 60, of the pronunciation “r iy z uw m” is higher than the confidence score, 40, of the pronunciation “r eh z ax m ey”, so that the labeling column 14 might mark the row of the confidence score of the pronunciation “r iy z uw m”.

In addition, the order of words could be adjusted according to the confidence scores. Users could set the pronunciations having the higher confidence scores displayed in the front or in the bottom of the user interface based on their common usage.

Furthermore, as illustrated in FIG. 1, the word, the pronunciation, and the source corresponding to one of the confidence scores are labeled with the same color of the specific confidence score. That is to say, in FIG. 1, different rows with various confidence-scores are labeled with different colors, thereby facilitating the correction. More specifically, the displaying color in the row of the pronunciation “r eh z ax m ey” is different form that of the pronunciation “r iy z uw m”, which is contributed to be distinguishable to be selected by users.

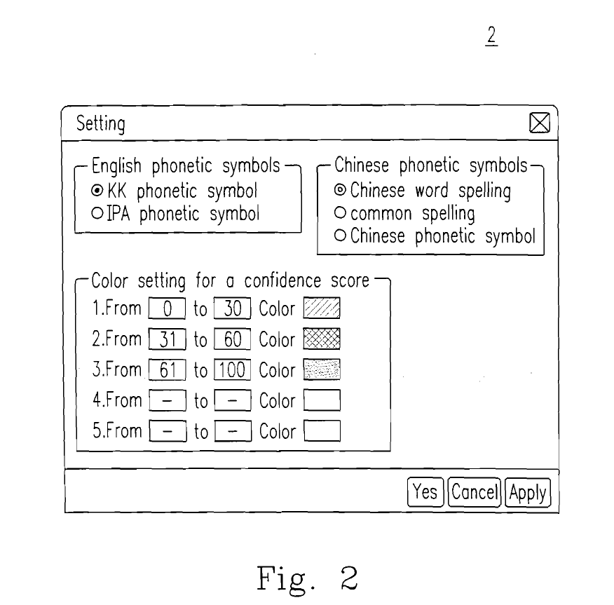

Besides, the interface 1 further comprises a setting button 15 installed for an entry into a sub-interface 2 as illustrated ‘in FIG. 2 so as to further set the displaying color therein. Please refer to FIG. 2, which depicts a schematic diagram of a color-setting interface in the user interface for a text-to-phone conversion according to the present invention. The displaying color of each confidence-score could be modified corresponding to the pre-defined ranges for the confidence scores.

An additional feature of the present invention is that the vocabulary column 10, the pronunciation column 11, the category column 12, and the index column 13 existing in the interface 1 could be sorted based on the individual user's preference, and thus the whole page of the user interface for a text-to-phone conversion becomes more user-friendly.

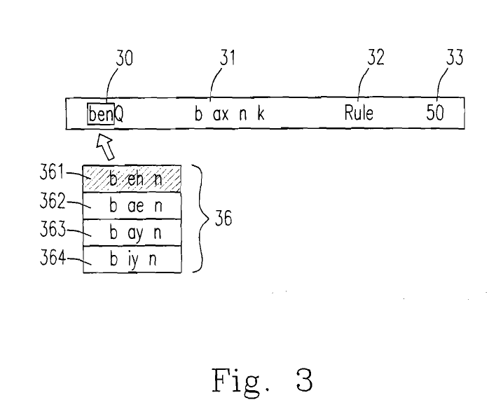

The second distinguishable feature of the present invention is to provide a method for correcting the user interface for a text-to-phone conversion. More specifically, there provides a correctable interface applicable in the mentioned user interface system for a text-to-phone conversion. Please refer to FIG. 3, which depicts a schematic diagram of a user interface for a text-to-phone conversion and the method for correcting the user interface according to a preferred embodiment of the present invention, and it is illustrated based on a specific single row of FIG. 1. As illustrated in FIG. 3, a part of the English letters of a word 30 is selected through an input interface, such as a keyboard, a mouse, a touch panel, or a stylus, and then a phonetic symbol menu 36 corresponding to the selected part of the English word is displayed. The phonetic symbol menu 36 comprises a plurality of sub-pronunciations 36x corresponding to the selected English letters of the word 30. Each of the plurality of sub-pronunciations comprises a plurality of phonetic symbols, and a part of the pronunciation 31 corresponding to the word 30 is determined by each of the plurality of sub-pronunciations. Subsequently, one of the plurality of sub-pronunciations is selected by means of the mentioned input interface, so that the corresponding pronunciation 31 is also changed. Accordingly, a more appropriate acoustic model corresponding to the word is provided for a further speech recognition.

Moreover, taking a real word “BenQ” illustrated in FIG. 3 for a further example, while a part “Ben” of the word “BenQ” is selected to be marked by the input interface, a set of sub-pronunciations 361-364 corresponding to the marked parts are displayed. If the sub-pronunciation 361 is selected, the original pronunciation “b ax n k” could be converted into the pronunciation “b eh n k y uw”.

The third distinguishable technical feature of the present invention is also to provide a method for correcting the pronunciations. More specifically, there provides a correctable interface applicable in the mentioned user interface system for a text-to-phone conversion. The inethod for correcting the user interface for a text-to-phone conversion could be automatically performed by the speech recognition.

The mentioned word “BenQ” is also taken as an example for description.

The detailed operational procedure is interpreted below. Firstly, the word “BenQ” to be corrected is selected through a user interface, such as a browse key, a mouse or a stylus. Secondly, the user pronounces the word “BenQ” to a mike, where the system will automatically undergo the speech recognition after receiving the speech of the word “BenQ”. Since the word to be corrected has been selected, the possible pronunciations thereof could be limited based on the pronunciation combinations of each letter:
(1) the pronunciation “b” could be “b”;
(2) the pronunciation “e” could be “eh”, “ae”, “iy”, “ih” and “ay” or none;
(3) the pronunciation “n” could be “n” and “ng”; and
(4) the pronunciation “Q” could be “k” and “kyuw”.

Therefore, the pronunciations of the word “BenQ” will be limited to the following narrower recognizing ranges:

1. <b eh n k>

2. <b ae n k>

3. <b iy nk>

4. <b ih n k>

5. <b ay n k>

6. <b n k>

7. <b eh ng k>

8. <b ae ng k>

9. <b iy ng k>

10. <b ih ng k>

11. <b ay ng k>

12. <b ng k>

13. <b eh n k y uw>

14. <b ae n k y uw>

15. <b iy n k y uw>

16. <b ih n k y uw>

17. <b ay n k y uw>

18. <b n k y uw>

19. <b eh ng k y uw>

20. <b ae ng k y uw>

21. <b iy ng k y uw>

22. <b ih ng k y uw>

23. <b ay ng k y uw>

24. <b ng k y uw>

One of the mentioned twenty-four pronunciations is provided to be selected to serve as the final pronunciation, and then the selected pronunciation of the word “BenQ” is displayed in the pronunciation column 11, followed by correcting the source in the category column 12 as the speech correction.

This kind of correctable interface by means of an automatic speech recognition is superior in that a better result is attainable by a limited number of the pronunciation candidates (24 pronunciations in this embodiment) or constraining the recognizing results in the speech recognition to be narrower by means of a language model. Therefore, a more appropriate pronunciation could be obtained. Contrary to the prior art without a limited lexicon, the correctable interface and the method thereof of the present invention are advantageous in achieving a more accurate speech recognition result and avoiding the circumstance of displaying an unexpected result.

The present invention is also advantageous in that there is no need for a keyboard to directly input phonetic symbols for a further correction, which brings great convenience to those who don‘t know how to edit the phonetic symbols. The present invention is especially applicable to the portable device with a mini-screen.

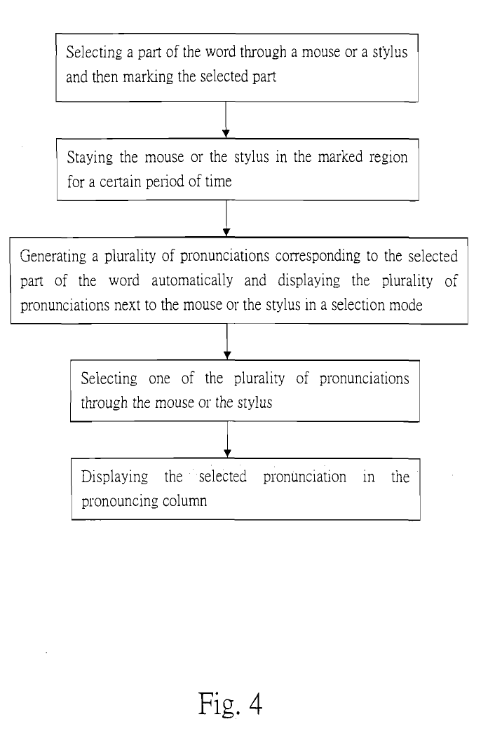

Please refer to FIG. 4 which depicts a flowchart of the operational procedure corresponding to FIG. 3. Most steps illustrated in FIG. 4 are similar to those shown in FIG. 3. An additional step illustrated in FIG. 4 is to select the marked region through the input interface for a certain period of time, so as to start a second layer of the pronouncing phonetic symbol menu 36. However, the mentioned step is able to be achieved by the skilled person in the filed so that the detailed interpretation therefor needs no furter description herein.

Finally, an improvement to the correctable user interface system for a text-to-phone conversion in FIG. 4 could be further implemented by means of automatic speech recognition rather than the original manual input manner, including the keyboard, the mouse, the touch panel and the stylus. The above word “BenQ” is also taken for example. Users could only pronounce a part of the word, “Ben”, to a mike, wherein the speech for “ben” would subsequently be recognized by the user interface system automatically. There might generate a plurality of sub-pronunciations 36x in the user interface and one of the sub-pronunciations 36x will be selected based on the mentioned pronunciation to define the word pronunciation 31. This kind of speech recognition is superior in saving the time to select the sub-pronunciations 36x illustrated in FIG. 4. Therefore, the efficiency of the recognition procedure could be extremely raised.

As the above, the possible errors generated during the process of a text-to-phone conversion could be displayed in the GUI labeled with different colors in the present invention. With such labeling, the possible errors could be easily identified. Furthermore, words having higher confidence score could be displayed sequentially, so that the user easily takes a glance at the marked words and the phonetic symbols without scrolling the scroll bar. Therefore, time could be saved by focusing on the correction of the pronunciation. The method for correcting the user interface for a text-to-phone conversion in the present invention provides a limited number of the possible pronunciations to be selected by means of the various kinds of input interfaces, or provides a limited number of the possible pronunciations to constrain the lexicon used in the search process, so that a more accurate pronunciation could be generated to facilitate the subsequent speech recognition. Therefore, the present invention could highly increase the processing rate and the usage convenience of the correctable interface during the text-to-phone conversion.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An user interface for a text-to-phone conversion, the user interface comprising:
a vocabulary column displaying a word;
a pronunciation column displaying a pronunciation corresponding to the word;
a category column displaying a specific source corresponding to the pronunciation; and
an index column displaying a specific confidence score corresponding to the pronunciation.

2. A user interface for a text-to-phone conversion as claimed in claim 1, wherein the vocabulary is presented in one of Chinese and English.

3. A user interface for a text-to-phone conversion as claimed in claim 1, wherein the specific source is one selected from a group consisting of a frequently-used-word (FUW) database, a pronouncing dictionary, a speech correction, and a pronouncing rule.

4. A user interface for a text-to-phone conversion as claimed in claim 1, further comprising a labeling column identifying whether the pronunciation is selected for a further process by speech recognition.

5. A user interface for a text-to-phone conversion as claimed in claim 1, wherein the word, the pronunciation, and the specific source corresponding to the specific confidence score are displayed in the same color of the specific confidence score.

6. A user interface for a text-to-phone conversion as claimed in claim 5, further comprising a setting interface setting a color for the specific confidence score.

7. A user interface for a text-to-phone conversion as claimed in claim 1, further comprising a sub-pronunciation selecting menu displaying a specific sub-pronunciation corresponding to a part of the word, wherein the specific sub-pronunciation includes a pronouncing phonetic symbol, and a part of the pronunciation is determined by the specific sub-pronunciation.

8. A user interface for a text-to-phone conversion as claimed in claim 7, further comprising an input interface to select a respective sub-pronunciation for the part of the word.

9. A user interface for a text-to-phone conversion as claimed in claim 8, wherein the input interface is one selected from a group consisting of a keyboard, a mouse, a touch panel, a stylus, and a speech input device.

10. A method for correcting the results of a text-to-phone conversion in a user interface, the user interface comprising a vocabulary column, a pronunciation column, and an index columin, wherein the vocabulary column displays a word, the pronunciation column displays a specific pronunciation corresponding to the word, and the index column displays specific confidence score corresponding to the specific pronunciation, the method comprising steps of:
selecting a part of the word;
displaying a plurality of sub-pronunciations corresponding to the selected part of the word, wherein the selected sub-pronunciation determines a part of the pronunciation of the word; and
selecting a desired one from the plurality of sub-pronunciations for correcting the part of the pronunciation.

11. A method for correcting the results of a text-to-phone conversion in a user interface as claimed in claim 10, wherein the vocabulary is in one of Chinese and English.

12. A method for correcting the results of a text-to-phone conversion in a user interface as claimed in claim 10, wherein the user interface is provided for selecting the part of the word and the respective sub-pronunciation.

13. A method for correcting the results of a text-to-phone conversion in a user interface, the user interface comprising a vocabulary column, a pronunciation column, and an index column, wherein the vocabulary column displays a word, the pronunciation column displays a pronunciation corresponding to the word, and the index column displays a specific confidence score corresponding to each the corresponding pronunciation, the method comprising steps of:
selecting a word to provide a lexicon, the lexicon including a first plurality of pronunciations corresponding to the selected word;
inputting a respective speech of the selected word to the user interface;
starting a speech recognition to obtain a second plurality of pronunciations to the selected word; and
selecting a desired one from the second plurality of pronunciations and displaying the selected one.

14. A method for correcting the results of a text-to-phone conversion in a user interface as claimed in claim 13, wherein the lexicon is provided from a specific pronouncing combination of the word.

15. A method for correcting the results of a text-to-phone conversion in a user interface as claimed in claim 13, wherein the vocabulary is one of Chinese and English.

16. A method for correcting the results of a text-to-phone conversion in a user interface as claimed in claim 13, wherein the user interface further comprises a category column displaying a source corresponding to the pronunciation.

17. A method for correcting the results of a text-to-phone conversion in a user interface as claimed in claim 16, wherein the source is one selected from a group consisting of a frequently-used-word (FUW) database, a pronouncing dictionary, a speech correction, and a pronouncing rule.

18. A method for correcting the results of a text-to-phone conversion in a user interface as claimed in claim 16, wherein the word, the pronunciation, and the specific source corresponding to the specific confidence score are displayed in the same color of the specific confidence score.

19. A method for correcting the results of a text-to-phone conversion in a user interface as claimed in claim 18, wherein the user interface further comprises a color-setting sub-interface, and the method further comprises a step of changing a color displayed in the color-setting sub-interface.

20. A method for correcting the results of a text-to-phone conversion in a user interface as claimed in claim 18, wherein the user interface further comprises a labeling column, and the method further comprises a step of determining whether the pronunciation corresponding to the word is selected.
